(19) United States
(12) Patent Application Publication
(10) Pub. No.: US 2007/0173102 A1
(43) Pub. Date: Jul. 26, 2007

(54) Motor-vehicle electrical connector assembly

(75) Inventors: Rudolf Fekonia, Munich (DE); Peter Muller, Bruckberg (DE); Michael Respondek, Mengkofen (DE); Arnold Federer, Goetzis (DE)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/654,405

(22) Filed: Jan. 17, 2007

(30) Foreign Application Priority Data
Jan. 20, 2006 (DE) 102006002774.4

(51) Int. Cl. H01R 4/24

(52) U.S. Cl. 439/398

(57) ABSTRACT

A wire having a conductive core surrounded by an insulation sheath if fitted to an electrical connector having a housing formed with a passage receiving the wire and having an end region surrounding a stripped end of the wire where the conductor is exposed and an intermediate region surround an adjacent portion of the sheath of the wire. An element in the intermediate region fixed to the sheath secures the wire in the housing against any movement relative thereto.

### FIELD OF THE INVENTION

The present invention relates to an electrical connector. More particularly this invention concerns such a connector used in a motor vehicle to make an electrical connection to a hookup wire.

### BRIEF DESCRIPTION OF THE DRAWING

The above and other objects, features, and advantages will become more readily apparent from the following description, reference being made to the accompanying drawing in which:

FIG. 2 is an axial section through a prior-art connector; and

FIG. 1 is an axial section through the connector according to the invention.

### BACKGROUND OF THE INVENTION

Plugs or electrical connectors, in particular for use in automobiles, are known. One illustrated embodiment of a known plug-in connector is shown in FIG. 1 at 10. It has a dielectric plastic connector housing 11 forming at least one passage 12, typically several such passages, in which the end region of a wire 13 is introduced. The passage 12 is of cylindrical shape and centered on an axis A. The cross section of the passage 12 is larger than that of the wire 13, thus leaving some play therebetween. A terminal 14 is mounted, in particular by means of a crimped connection 15, on the electrical conductor of the wire 13 at the end thereof in a large-diameter end region 19 of the passage 12. Insulation for establishing a longitudinal waterproof seal between the terminal 14 and the wire 13 is provided by means of a crimped insulation sleeve 16. To prevent the terminal 14 from pulling out of the passage 12 after being inserted therein, the terminal 14 is fixed in place (also referred to as a primary lock) in the connector housing 11. This is achieved by use of one or more elastically spread clips 17 that are formed on the terminal 14. These clips 17 are compressed when the terminal 14 is inserted into the passage 12, and spread out when the terminal 14 has reached its end position in the connector housing 11.

The plug-in connector 10 has a coaxial housing opening 18 of smaller diameter than the passage 12 and region 19 for receiving a connector into which the terminal for the mating connector may be inserted. Although the primary lock for the terminal 14 in the passage 12 of the connector housing 11 in principle prevents the terminal 14 from being moved out of the connector housing 11, in this design of the prior art the terminal 14 is not prevented from moving, in particular axially within the passage 12 relative to the connector housing 11. Such movement may be caused by tension and pressure stresses on the wire 13, vibrations in the environment in which the plug-in connector 10 is used, temperature fluctuations, and the like. Consideration has been given to appropriate measures (also referred to as strain relief) for eliminating these tensile and pressure stresses on the wire 13. However, the transmission of vibrations from the wire 13 to the housing opening 18 and to the terminal 14 as well as its complementary terminal for the mating connector is still not prevented, resulting in frictional corrosion and surface wear, and therefore leads to increases in resistance and possible contact interruptions. A further disadvantage of these known plug-in connectors is that the terminal 14 may jam inside the passage 12 as a result of the mounted wire 13, which in turn has harmful and disadvantageous effects on the housing opening 18.

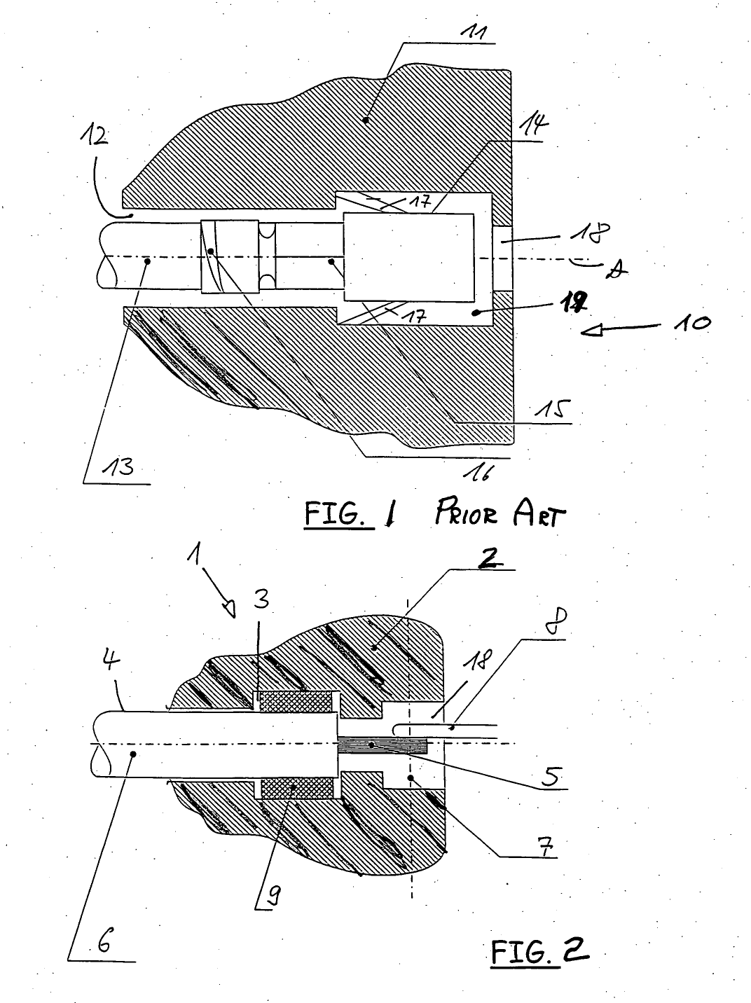

Another embodiment of a plug-in connector is known from U.S. Pat. No. 6,736,682. The advantage of this known plug-in connection is that there is no terminal being mounted on the end of the electrical conductor for the wire. To absorb the plug-in forces when the plug and electrical connector are joined, both the end region of the electrical wire and the exposed electrical conductor are fixed in place by the connector housing. The embodiment according to FIG. 2 of U.S. Pat. No. 6,736,682 reliably provides strain relief for the wire by the fact that the wire is surrounded by the connector housing, in particular by extrusion coating. However, manufacture of such a design is extremely complex, since in the extrusion coating process care must be taken that the end region of the wire is completely extrusion-coated with plastic, while on the other hand the exposed electrical conductor must be only partially extrusion-coated with the plastic of the connector housing, since the electrical conductor must likewise be fixed in the connector housing, and in addition a portion of the electrical conductor must remain exposed so that electrical contact may be made with the complementary end region of the electrical conductor for the electrical connector. Such a design for a plug-in connector can be implemented only with great difficulty, since coordination during the injection molding process, in particular for multicontact plug-in connectors, is extremely complicated and therefore very costly. Other systems described in German patent documents 42 35 245 and 101 02 137 and in U.S. Pat. No. 5,788,536 have similar problems.

### OBJECTS OF THE INVENTION

It is therefore an object of the present invention to provide an improved electrical connector.

Another object is the provision of such an improved electrical connector that overcomes the above-given disadvantages, in particular that avoids the above-described disadvantages, and which in particular for mass production represents a cost-effective and manufacturable approach in order to eliminate the possible defects previously known, in particular, wear and contact interruption.

### SUMMARY OF THE INVENTION

A wire having a conductive core surrounded by an insulation sheath if fitted to an electrical connector having according to the invention a housing formed with a passage receiving the wire and having an end region surrounding a stripped end of the wire where the conductor is exposed and an intermediate region surround an adjacent portion of the sheath of the wire. An element in the intermediate region fixed to the sheath secures the wire in the housing against any movement relative thereto.

Thus according to the invention, means are provided for fixing the end region of the wire to the connector housing in a play-free manner inside the passage in order to decouple the electrical conductor from forces acting on the wire. In other words, the connector housing is no longer directly injection-molded around the end region of the wire. Instead, these means are inserted into the passage as an additional component or components, and/or the means may be injection-molded to the connector housing, which is designed as a single part or as multiple parts. Thus, during manufacture of the plug-in connector no direct interaction is necessary between the extruded coating of the connector housing and the end region of the wire, thereby allowing the components used to be matched to one another in a much simpler and less complicated manner, resulting in a considerable reduction in cost. Thus, for example, the one- or multipart connector housing can be manufactured and matched to the geometric shapes of the electrical wire (cross-sectional shape or diameter) without having to insert the wire into the injection molding mold during manufacture of the connector housing. The same applies for the exposed electrical conductor for the wire, which may be made before the wire is installed in the connector housing. This way the electrical conductor itself may be designed as a terminal, or an additional terminal may be mounted on the electrical wire.

In particular, designing the means for fixing the end region of the wire in position in a play-free manner as a separate component (one- or multipart) has the advantage that these means may be optimally matched to the cross section of the passage, and to the cross section and axial extension of the wire. These means are then inserted into the passage, for example after the connector housing is manufactured, followed by installation of the electrical wire (with or without a terminal). Alternatively, it is also possible to mount the means on the end region of the electrical wire and to introduce this unit into the passage of the connector housing.

In one refinement of the invention, the position-fixing means may have a friction-fit and/or form-fit design. A friction fit is produced, for example, by gluing the outer sheathing of the wire to the inner contour of the passage. A form fit of the connection between the outer sheathing of the wire and the inner contour of the passage is implemented, for example, by a pressing or squeezing procedure, for which purpose, for example, the inner wall of the passage has ribs transverse to the axial extension of the wire which form a cross section that is smaller than the cross section of the wire, so that when the wire is introduced over these ribs, or when at least two parts of the multipart connector housing are joined, the outer contours of the ribs press against the outer sheathing and fix it in position in a play-free manner inside the connector housing, thereby decoupling the contact region from oscillations, vibrations, and other motions. It is also possible to make the play-free position-fixing means from an elastically deformable material whose cross section for accommodating the wire is smaller than the cross section of the wire, and the cross section of the material for insertion into the passage is larger than the cross section of the passage on which the means are used. The material is thus fixed in position in a form-fit manner as the result of squeezing the elastically deformable material.

On the whole, therefore, the invention offers the advantage that fixing of the wire in position, in particular the end region thereof, in the connector housing may be selected such that transmission of vibration through the electrical wire into the contacting region is prevented. This is achieved by fixing the wire in position in a play-free manner in the one- or multipart connector housing, in particular made of plastic, so that the contacting zone is decoupled. At the same time, the advantage is realized, in particular as the result of separate means for play-free position-fixing, that the geometries of the individual elements used may be matched to one another in a much more satisfactory manner, resulting in simplified and therefore less costly manufacture of plug-in connectors with greatly improved electrical properties (in particular, prevention of frictional corrosion and surface wear, and therefore reduction of increases in transition resistance and avoidance of contact interruptions).

Use of the invention is particularly advantageous in automobiles, in which severe environmental conditions are present, and in addition a large variety of parts is to be avoided. Furthermore, the plug-in connection must be robust and at the same time provide a very reliable contact. A further application is plug-in connections for industrial connectors subjected to intense vibrations, in particular in production and processing engineering. However, this listing is not exhaustive.

### SPECIFIC DESCRIPTION

As seen in FIG. 2 a plug-in connector 1, which may be joined with a complementary electrical connector to form a plug-in connection, has a connector housing 2, in particular a plastic housing. In the connector housing 2 a passage 3 or multiple passages 3 (in a row or in multiple rows) are provided, into which an end region of a wire 4 may be introduced. The wire 4 may be a circular, flat, or of other design. On its end the wire 4 has an exposed electrical conductor 5, which may likewise be a flat or circular conductor (wire or stranded conductor). The end region of the electrical conductor 5 is designed as a terminal, or a terminal (not illustrated) is mounted on it. The wire 4 has an outer dielectric plastic sheath 6. On its end face the connector housing 2 has a contact region 7 forming an extension of the passage 3 and designed for accommodating a mating connector 8 (or a terminal thereof). According to the invention, the end of the wire 4 is fixed in position to the connector housing 2 in a play-free manner inside the passage 3 via means 9 which has a friction-fit and/or form-fit design. The means 9 act in an advantageous manner such that the end of the electrical conductor 5 or a terminal mounted thereon, and in the joined state, also the mating connector 8 (or the terminal thereof), are vibrationally decoupled in order to avoid the described disadvantages.

The means 9 may advantageously be designed as a one- or multipart component that is separate from the wire 4 and the connector housing 2, but alternatively may also be a component of the outer sheathing 6 of the wire 4 and/or a component of the passage 3 of the connector housing 2.

In summary, the invention offers the advantage that, as a result of the form-fit and/or force-fit separation of the contact zone 7 from the fixing of the wire 4 and the means 9 to the connector housing 2, the transmission of vibration from the wire 4 into the contact region 7 is substantially excluded or completely eliminated, thereby essentially preventing surface wear of the terminals, which in turn results in much greater reliability of the plug-in connector contact and the service life thereof. If a design is selected such that the electrical conductor 5 is fixed to the connector housing 2, very high normal contact forces (preferably greater than 10 Newton) may be realized, so that an economical, reduced-weight, and reliable plug-in connection may be produced which can be easily implemented in both sealed and unsealed variants and above all is manufacturable in an unrestricted manner.

We claim:

1. In combination with a wire having a conductive core surrounded by an insulation sheath, an electrical connector comprising:
a housing formed with a passage receiving the wire and having an end region surrounding a stripped end of the wire where the conductor is exposed and an intermediate region surround an adjacent portion of the sheath of the wire; and
means including an element in the intermediate region fixed to the sheath for securing the wire in the housing against any movement relative thereto.

2. The connector defined in claim 1 wherein the element is integral with the insulation sheath.

3. The connector defined in claim 2 wherein the element is integral with the housing.

4. The connector defined in claim 1 wherein the element annularly surrounds the wire.

5. The connector defined in claim 4 wherein the element is a ring coaxial with the wire.

6. The connector defined in claim 1 wherein the wire is a ribbon cable having a plurality of coplanar such conductive cores, the element surrounding the ribbon cable.

7. The connector defined in claim 1 wherein the stripped end of the conductive core is formed as a terminal.

8. The connector defined in claim 7 wherein the terminal is formed as one of a pair of interfitting terminals.

9. The connector defined in claim 1 wherein the housing is of one piece.

10. The connector defined in claim 1 wherein the housing is formed of at least two parts.
